(19) United States
(12) Patent Application Publication
(10) Pub. No.: US 2011/0308057 A1
(43) Pub. Date: Dec. 22, 2011

(54) DEVICE TO OPEN BUCKLES FOR CHILD SAFETY SEATS

(76) Inventors: Vance Abrams, Castaic, CA (US); Linda Abrams, Castaic, CA (US)

(21) Appl. No.: 12/816,445

(22) Filed: Jun. 16, 2010

(51) Int. Cl. B25B 27/00

(52) U.S. Cl. 29/426.5; 29/270

(57) ABSTRACT

A device to open buckles for child safety seats includes a first jaw having a first handle and a gripping surface adapted to press against the rear surface of the buckle; and a second jaw having a second handle and a knob that extends generally perpendicular to the second jaw. The first jaw is pivotally connected to the second jaw so that when the first handle is forced toward the second handle, the knob is urged toward the gripping surface so as to compress the button toward the rear surface, thereby opening the buckle. The device includes an attachment mechanism to store the device when the device is not in use.

### BACKGROUND OF THE INVENTION

The present invention generally relates to tools for opening buckles and more specifically to a device to open buckles for child safety seats.

Child safety seats or restraining seats, such as for automobiles, have restraining straps that are held together with a buckle. The child is placed in the seat, and the straps are inserted into the buckle so that the buckle is in a closed position. To open the buckle, the user depresses a depressible button on top of the buckle, releasing the straps.

It can be difficult to open the buckle of these child safety seats. Persons with arthritis or other weakness of the hands may have problems. These buckles may have different requirements from the seat belts for the car seats, and may require more compression on the button to open the buckle.

It would be desirable to have a tool for opening the buckle of a child restraining seat.

### SUMMARY OF THE INVENTION

In one aspect of the present invention, a device includes a first jaw having a first handle; a gripping surface on the first jaw; a second jaw having a second handle; a knob on the second jaw that extends generally perpendicular to an axis of the second jaw; and a hinge pivotally connecting the first jaw to the second jaw; wherein when the first handle is forced toward the second handle, the knob is urged toward the gripping surface.

In another aspect of the present invention, a device to open a buckle for the restraining straps of a child safety seat, the buckle having a rear surface and a front surface with a button, where the device includes a first jaw having a first handle and a gripping surface adapted to press against the rear surface of the buckle; and a second jaw having a second handle and a knob that extends generally perpendicular to the second jaw; wherein the first jaw is pivotally connected to the second jaw so that when the first handle is forced toward the second handle, the knob is urged toward the gripping surface so as to compress the button toward the rear surface, thereby opening the buckle.

### BRIEF DESCRIPTION OF THE DRAWINGS

FIG. 1 depicts a side view of an embodiment of the present invention;

FIG. 2 depicts a side view of an embodiment of an attachment mechanism according to the present invention;

FIG. 3 depicts a perspective view of the embodiment of FIG. 1 with attachment mechanism;

FIG. 4 depicts the embodiment of FIG. 1 with a closed buckle; and

FIG. 5 depicts the embodiment of FIG. 1 being used to open the buckle.

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

An embodiment of the present invention generally provides a tool to open buckles for child safety seats.

An embodiment of a device may include pliers with two jaws, to be used to open the buckle of a child-restraining seat. One jaw may have a knob that extends out and away from the jaw, and may be a bolt or nub that is generally perpendicular to the jaw. The other jaw may have a gripping surface to grip the back of a buckle, so that the knob will press into the button of the buckle.

An embodiment of jaws may have handles and the jaws may be pivotally connected at a hinge, so that when the user squeezes the handles together, the knob is urged toward the gripping surface. This makes the knob press the button into the buckle, to open the buckle and release the straps.

When an embodiment of the device is opened, the jaws may separate sufficiently so that the distance between the gripping surface and the knob can be at least two inches. This may allow the pliers to accommodate the belt buckle. The handles may be limited so they do not separate by a distance of more than four inches. This may allow the user to grasp both handles in one hand. When an embodiment of the device is closed, the knob may not make contact with the gripping surface, maintaining a separation of at least one inch. This may help provide safety, so that the pliers do not pinch fingers.

An embodiment may include an attachment mechanism to store the device. The attachment mechanism may include a clip, a cord, or a clip on a cord with a retractable reel, so that the device can be clipped to something for storage and utilized by pulling the cord out of the reel. The attachment mechanism may be attached to one of the handles, possibly near the end of the handle. The clip may be used to store the pliers on the safety seat, on the straps of the safety seat, or on a part of the car where the safety seat is to be used.

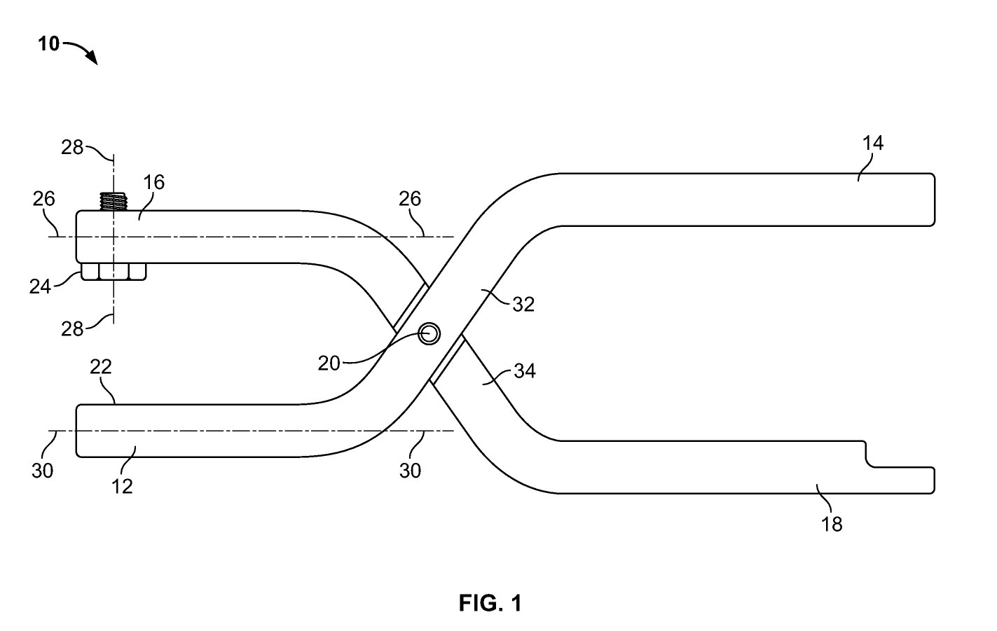

As depicted in FIG. 1, an embodiment may include a device 10 or pliers having a lower jaw 12 with a lower-jaw handle 14, an upper jaw 16 with an upper-jaw handle 18, and a hinge 20 to pivotally connect the two jaws with handles. Lower jaw 12 may have a gripping surface 22 to press upon the back of the buckle, and upper jaw 16 may have a knob 24 that extends away from the upper jaw 16 to press upon a depressible button of the buckle. Upper jaw 16 may have a central axis 26 and knob 24 may have a central axis 28 that is generally perpendicular to axis 26. Lower jaw 12 may have a central axis 30. The lower-jaw handle 14 may be connected to the lower jaw 12 with a lower offset connector 32, and the upper-jaw handle 18 may be connected to the upper jaw 16 with an upper offset connector 34, that align the jaws 12, 16 so that when the device 10 is used, the central axis 26 of upper jaw 16 and the central axis 30 of lower jaw 12 may be approximately parallel so as to apply a strong force.

The knob 24 may be an extension attached to the jaw 16, or it may be a bolt or screw inserted into the jaw 16. The knob 24 should be long enough so that it can depress the button of the buckle sufficiently to open the buckle, and jaws 12 and 16 should also separate far enough so that the jaws can wrap around and grasp the buckle. The device 10 may be made of plastic, metal, or any relatively rigid material. In an embodiment, handles 14 and 18 may make contact with each other before jaws 12 and 16 meet, to provide a minimum separation between jaws for safety.

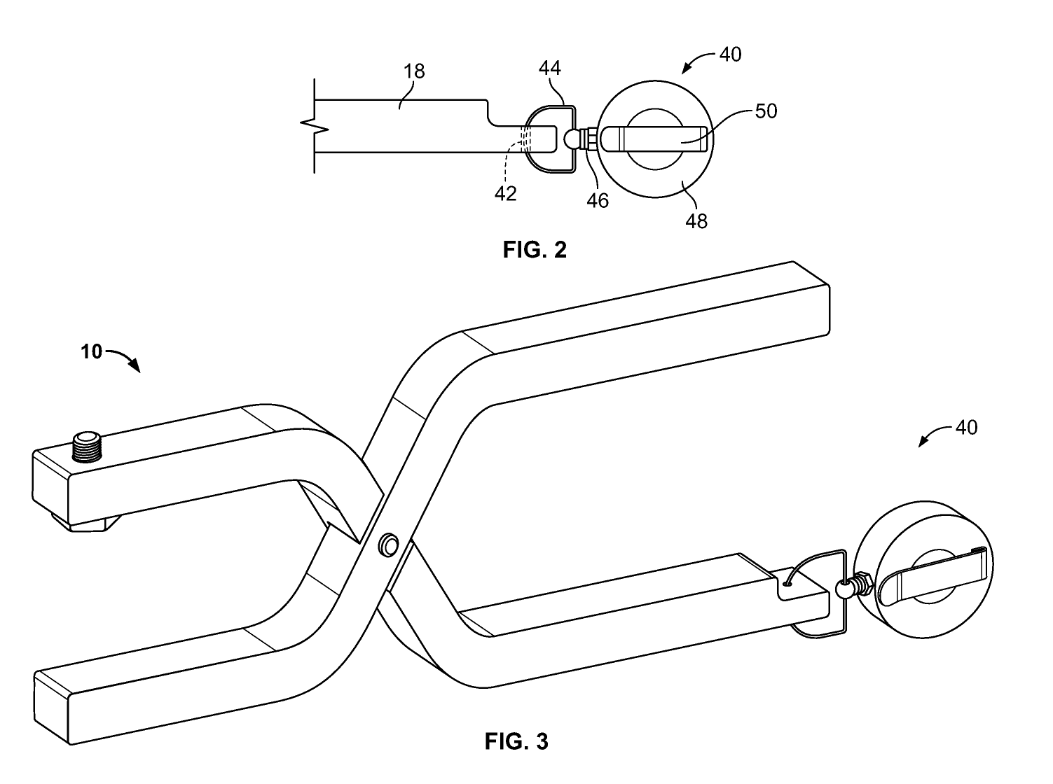

As depicted in FIG. 2, embodiments of upper-jaw handle 18 or lower-jaw handle or both may have an attachment mechanism 40 near the end of the handle. Attachment mechanism 40 may include an aperture 42 in upper-jaw handle 18. A ring 44 such as a D-ring may be inserted through the aperture 42, and may attach to a cable 46 or other cord. A retractable reel 48 may be included to retain the cable 46. A clip 50 or other gripping or grabbing mechanism may be included, either at one end of the cable 46 or on a reel 48, to clip the tool to the safety seat, the straps of the safety seat, or to a portion of a car where the seat is used. FIG. 3 depicts an embodiment of the device 10 with the attachment mechanism 40.

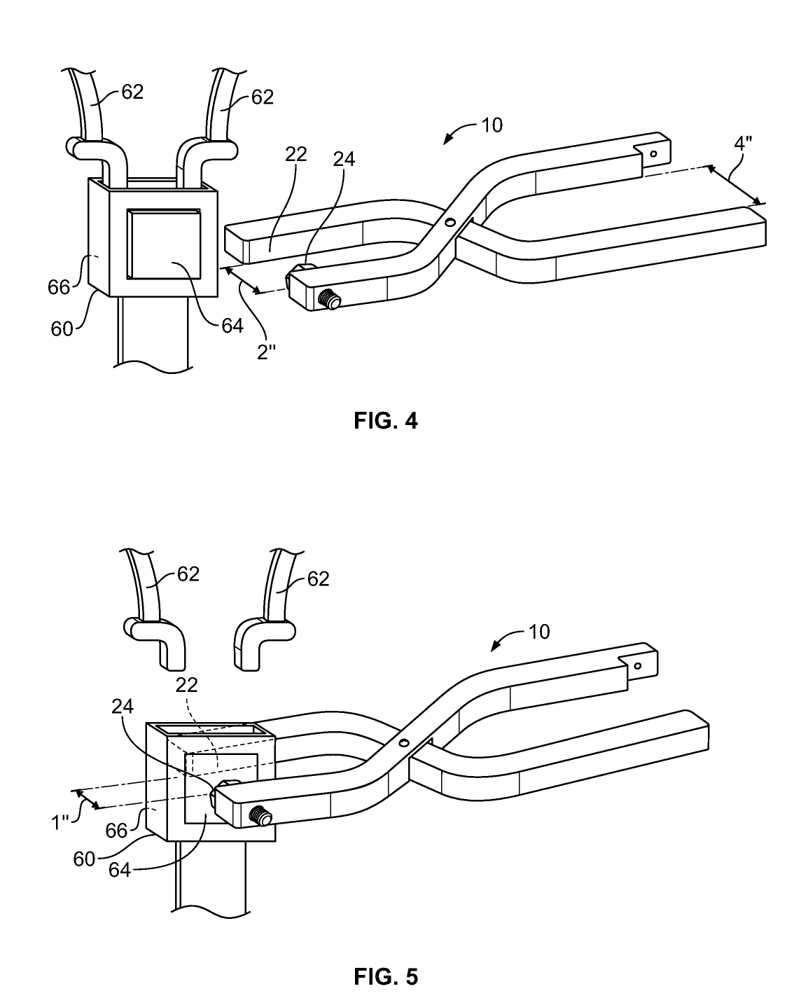

As depicted in FIGS. 4 and 5, an embodiment of a device 10 may be used on a buckle 60 such as a child safety seat buckle, having removable straps 62, a button 64 on the front, and a rear surface 66 on the back.

To make an embodiment, one may extrude or form two plastic parts for the jaws and handles, and bolt the parts together with plastic pivot hinge. One may add an extension to one jaw, or the knob may be part of the plastic part when it is formed.

I claim:

1. A device comprising:
a first jaw having a first handle;
a gripping surface on the first jaw;
a second jaw having a second handle;
a knob on the second jaw that extends generally perpendicular to an axis of the second jaw; and
a hinge pivotally connecting the first jaw to the second jaw;
wherein when the first handle is forced toward the second handle, the knob is urged toward the gripping surface.

2. The device of claim 1, wherein the device is adapted to open a buckle having a rear surface and a front surface with a button;
the gripping surface is adapted to press against the rear surface of the buckle; and
the knob is adapted to compress the button toward the rear surface, thereby opening the buckle.

3. The device of claim 1, wherein the buckle is a buckle for the restraining straps of a child safety seat and a hand can be utilized to force the first handle toward the second handle so that the device releases the straps from buckle.

4. The device of claim 1, wherein the first jaw separates from the second jaw so that, when the device is opened, the distance between the gripping surface and the knob is at least two inches.

5. The device of claim 1, wherein the first handle separates from the second handle by a distance of no more than five inches.

6. The device of claim 1, wherein the first jaw is separated from the second jaw so that, when the device is closed, the knob does not make contact with the gripping surface.

7. The device of claim 1, further comprising:
an attachment mechanism near an end of either the first or second handle, adapted to attach the device so as to store the device.

8. The device of claim 7, wherein the attachment mechanism includes:
an aperture in the first or second handle of the device;
a ring through the aperture;
a cord attached to the ring; and
a clip attached to the cord.

9. The device of claim 1, further comprising:
an aperture in the device;
a ring through the aperture;
a cord attached to the ring;
a reel to retain the cord; and
a clip attached to the reel.

10. The device of claim 1, wherein the buckle is a buckle for the restraining straps of a child safety seat, further comprising:
an attachment mechanism adapted to attach the device to the child safety seat.

11. The device of claim 1, further comprising:
a first offset connector connecting the first handle to the first jaw, the first jaw having a first axis; and
a second offset connector connecting the second handle to the second jaw, the second jaw having a second axis;
wherein, when the device is used, the first and second axis may be approximately parallel so that the knob is urged toward the gripping surface.

12. A device to open a buckle for the restraining straps of a child safety seat, the buckle having a rear surface and a front surface with a button, the device comprising:
a first jaw having a first handle and a gripping surface adapted to press against the rear surface of the buckle; and
a second jaw having a second handle and a knob that extends generally perpendicular to the second jaw;
wherein the first jaw is pivotally connected to the second jaw so that when the first handle is forced toward the second handle, the knob is urged toward the gripping surface so as to compress the button toward the rear surface, thereby opening the buckle.

13. The device of claim 12, wherein the distance between the gripping surface and the knob is at least two inches, and the first handle separates from the second handle by a distance of no more than five inches so that a hand can be utilized to force the first handle toward the second handle to open the buckle

14. The device of claim 12, further comprising:
an attachment mechanism to store the device when the device is not in use.

15. The device of claim 12, further comprising:
a cord attached to the device;
a reel to retain the cord; and
a clip on the reel, so that the device can be clipped for storage and utilized by pulling the cord from the reel.

16. The device of claim 12, further comprising:
a first offset connector connecting the first handle to the first jaw, the first jaw having a first axis;
a second offset connector connecting the second handle to the second jaw, the second jaw having a second axis; and
a hinge to pivotally connect the first offset connector with the second offset connector so that the first and second axis may be approximately parallel and the knob will be urged toward the gripping surface.

17. A method of opening a buckle for the restraining straps of a child safety seat, the buckle having a rear surface and a front surface with a button, the method comprising:
utilizing a pliers having a first jaw with a first handle and a gripping surface adapted to press against the rear surface of the buckle and a second jaw having a second handle and a knob that extends generally perpendicular to the second jaw, said first jaw pivotally connected to the second jaw so that when the first handle is forced toward the second handle, the knob is urged toward the gripping surface so as to compress the button toward the rear surface; and
utilizing said pliers to open the buckle.

18. The method of claim 17, further comprising:
attaching the pliers so as to store the pliers when the pliers are not in use.
